(19) United States
(12) Patent Application Publication
(10) Pub. No.: US 2011/0127366 A1
(43) Pub. Date: Jun. 2, 2011

(54) AUTOMATED SYSTEM FOR MANEUVERING AIRCRAFTS ON THE GROUND

(76) Inventor: Andreas Becker, Remscheid (DE)

(21) Appl. No.: 12/737,586

(22) PCT Filed: Jul. 9, 2009
(86) PCT No.: PCT/DE2009/000974

§ 371 Date: Jan. 28, 2011

(30) Foreign Application Priority Data
Jul. 29, 2008 (DE) 10 2008 035 342.6

(51) Int. Cl. B64F 1/04; B64F 1/22

(52) U.S. Cl. 244/50

(57) ABSTRACT

The invention relates to an automatic system for maneuvering aircraft on the ground, based on driverless towing vehicles, (hereafter AGTV's), which can independently hold the undercarriage of the aircraft. In said system the AGTVs pull the aircraft from transfer areas on the taxiways of the runways to the stand and vice versa, allowing the propulsion systems of the aircraft to remain switched off during the taxiing process. The driverless AGTVs receive their driving jobs from a computer-aided guidance and management system which controls the AGTV fleet in a collision- and conflict-free manner.

### BACKGROUND OF THE INVENTION

1. Field of the Invention

The invention is directed to an automated system for maneuvering aircrafts on the ground, based on driverless vehicles for maneuvering aircrafts, hereinafter AGTVs, which can independently receive the landing gears of aircrafts in order to pull or push them by means of a computer-aided guidance and management system for collision- and conflict-free routing of the AGTVs. AGTVs in the sense of the present invention are Automated Guided Towing Vehicles.

2. Description of the Prior Art

The prior art includes examples of towbarless towing vehicles for towing aircrafts (DE 19734238A1, DE 3534045A1, DE4415405C3, U.S. Pat. No. 5,308,212) in which the operating of the receiving device and the driving of the vehicle are performed by a driver. Due to the personnel requirements and the extensive communication with apron control, towing vehicles of this kind are currently used only for pushback and for gate-to-gate and maintenance towing.

The problem underlying the invention is to improve towing vehicles of the aforesaid kind in such a way that they are functionally and organizationally capable of performing driving tasks safely and without a driver. The resultant savings in personnel and reduction of verbal communication, together with the automation of guidance and control tasks, make it possible to expand the range of application of these vehicles to moving aircrafts on the ground from landing to takeoff, which will have an advantageous effect on the fuel consumption of the aircrafts and reduce noise and exhaust emissions in airport vicinities. Moreover, computer-aided routing of the AGTVs is advantageous for the prevention of accidents due to human error and misunderstandings during verbal communication.

### SUMMARY OF THE INVENTION

In the system according to the invention, towing vehicles of the aforesaid kind are equipped with a navigation system that makes it possible for the towing vehicle to navigate on the airfield and independently perform driving or towing tasks. Navigation is effected according to the invention by optical or inductive methods, by means of transponders, magnetic markers, GPS, or a combination of the aforesaid methods. The driverless AGTVs receive their driving or towing assignments from a computer-aided guidance and management system that controls the AGTVs in a collision- and conflict-free manner.

### BRIEF DESCRIPTION OF THE DRAWINGS

The invention is described in more detail hereinbelow on the basis of an exemplary embodiment depicted in the drawings. Therein:

FIG. 1 shows, by way of example and nonrestrictively, an airfield with an automated system for maneuvering aircrafts on the ground;

FIG. 2 shows a driverless vehicle for maneuvering aircrafts (AGTV), comprising a device for independently receiving the landing gear of an aircraft;

FIGS. 3a to 3c show, by way of example and nonrestrictively, various steering modes for improving the maneuverability of an AGTV;

FIG. 4 shows a transfer area with stationary sensors for better localization of the landing gears of the aircrafts;

FIGS. 5a to 5d show a driverless vehicle for maneuvering aircrafts (AGTV) comprising various sensor systems for safely approaching the landing gear of an aircraft, for precisely positioning the landing gear in the receiving device, for detecting obstacles in a timely manner, and for preventing collisions;

FIGS. 6a to 6b show a magnetic or inductive method for controlling driverless vehicles for maneuvering aircrafts (AGTVs);

FIG. 7 shows a method for controlling driverless vehicles for maneuvering aircrafts (AGTVs) by means of transponders;

FIG. 8 is a schematic diagram of the architecture of a control arrangement for an automated system for maneuvering aircrafts on the ground.

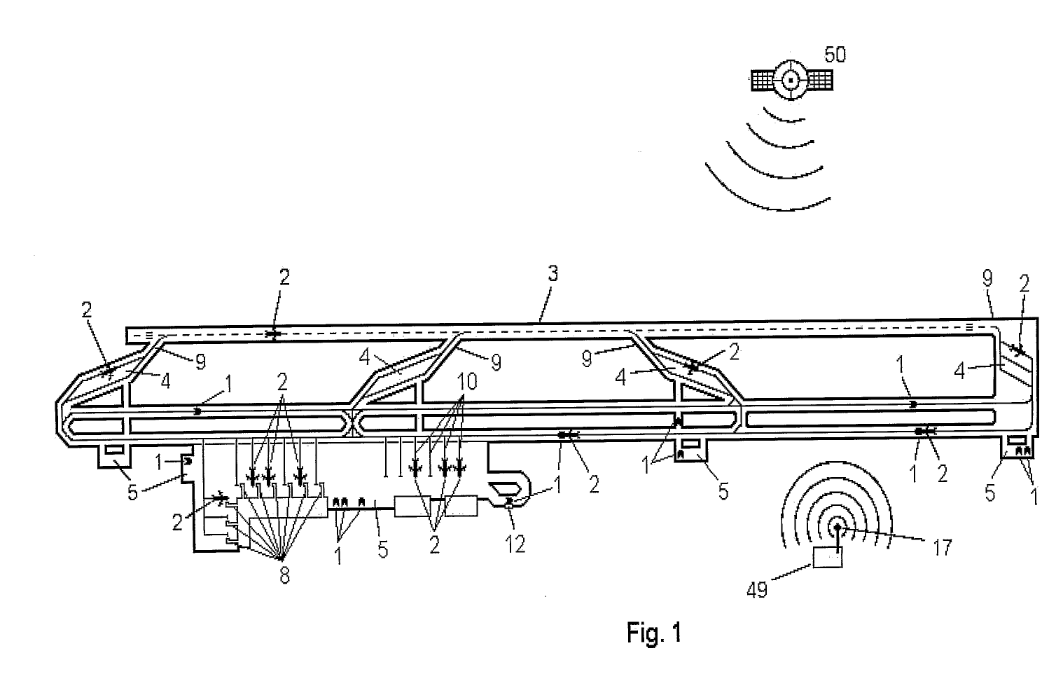

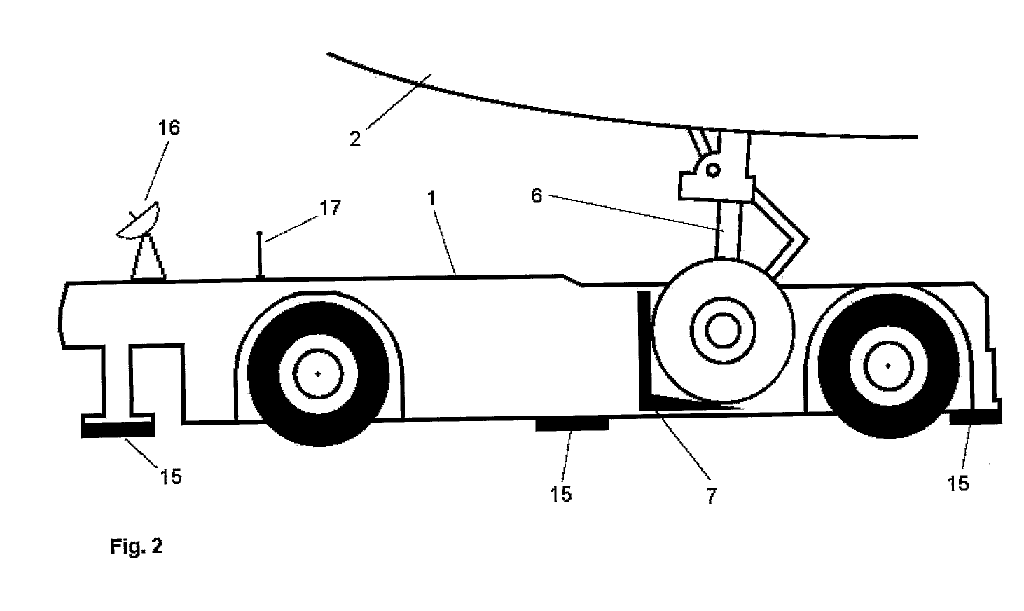

### DESCRIPTION OF THE PREFERRED EMBODIMENTS

The manner of operation of the system is as follows: After landing, the aircraft (2) taxis to transfer areas (4) located at the beginning and end and at the entrance and exit taxiways (9) of the runway (3).

In so doing, it follows the customary markings on airfields in order to stop at a defined transfer position (11) in one of the transfer areas (4). There, after a “spool-down time” specified by the manufacturer of the aircraft, the aircraft's engines are shut down. The operating personnel of the guidance and management system (49) now give the go-ahead for the towing task, which has been pre-input into the system. A towing task includes at least precise identification of the transfer position (11) of the aircraft, the type of aircraft, and the destination/parking position. The guidance and management system (49) then selects a free AGTV (1) suited to the type of aircraft concerned and guides it independently from a staging area (5) or its current location to the transfer position (11). Depending on the navigation method used, the route used can be static, or it can be computed dynamically by the guidance and management system (49). In both cases, the guidance and management system (49) determines a route that is both geographically and temporally disjunctive, to eliminate any possibility of collisions or conflicts with other AGTVs (1). The dimensions of the AGTVs (1), the types of aircraft being moved, and the associated turning behavior are all taken into account in this calculation.

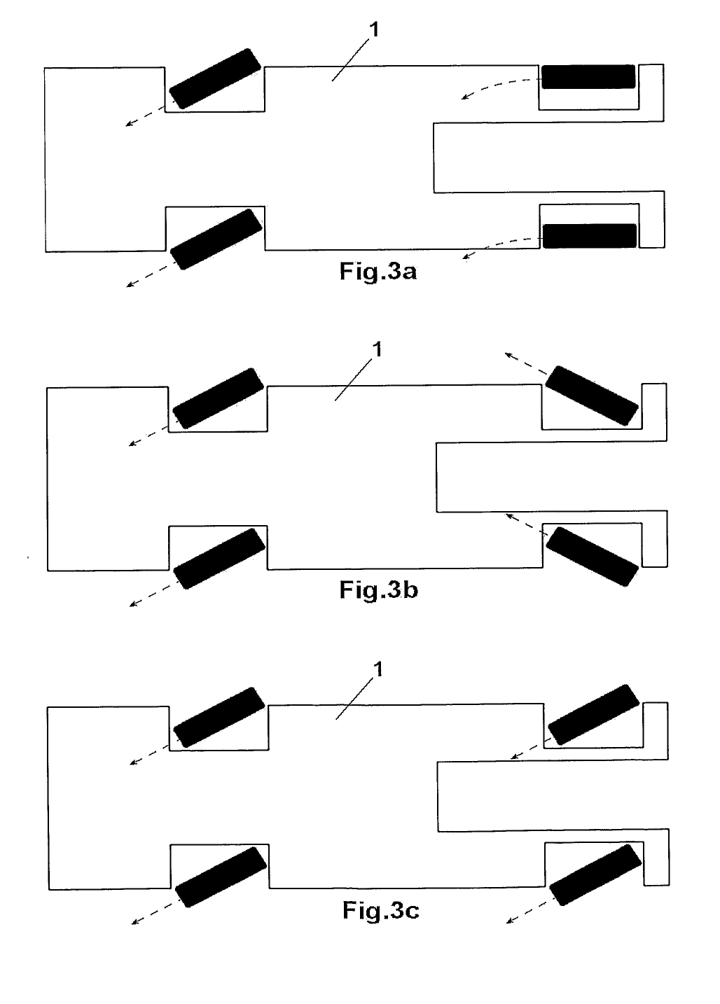

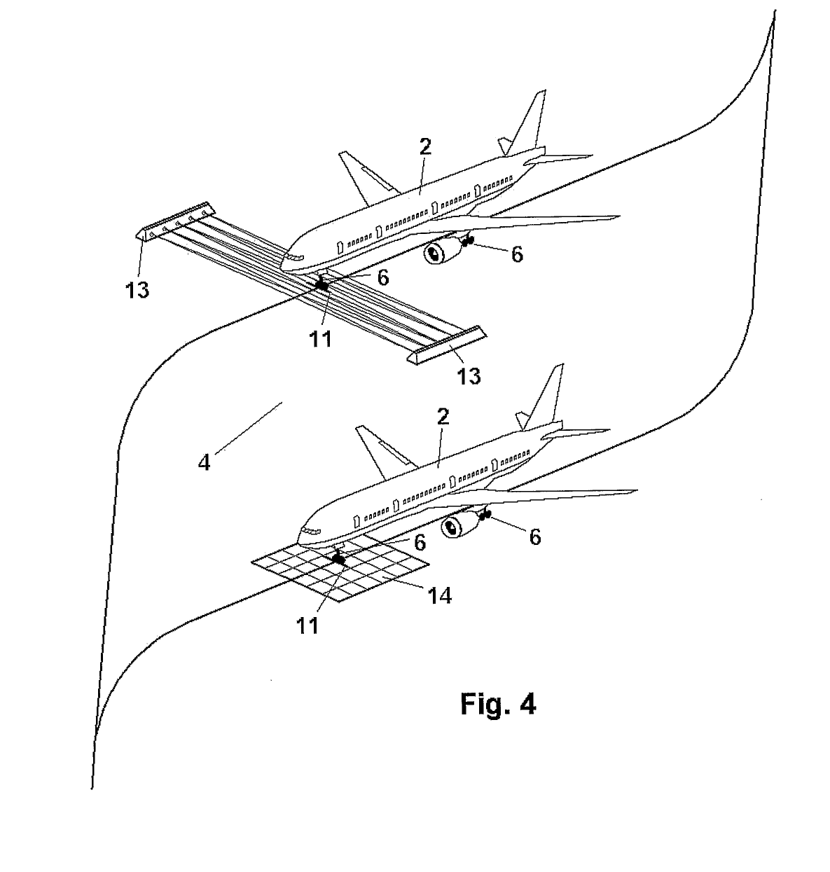

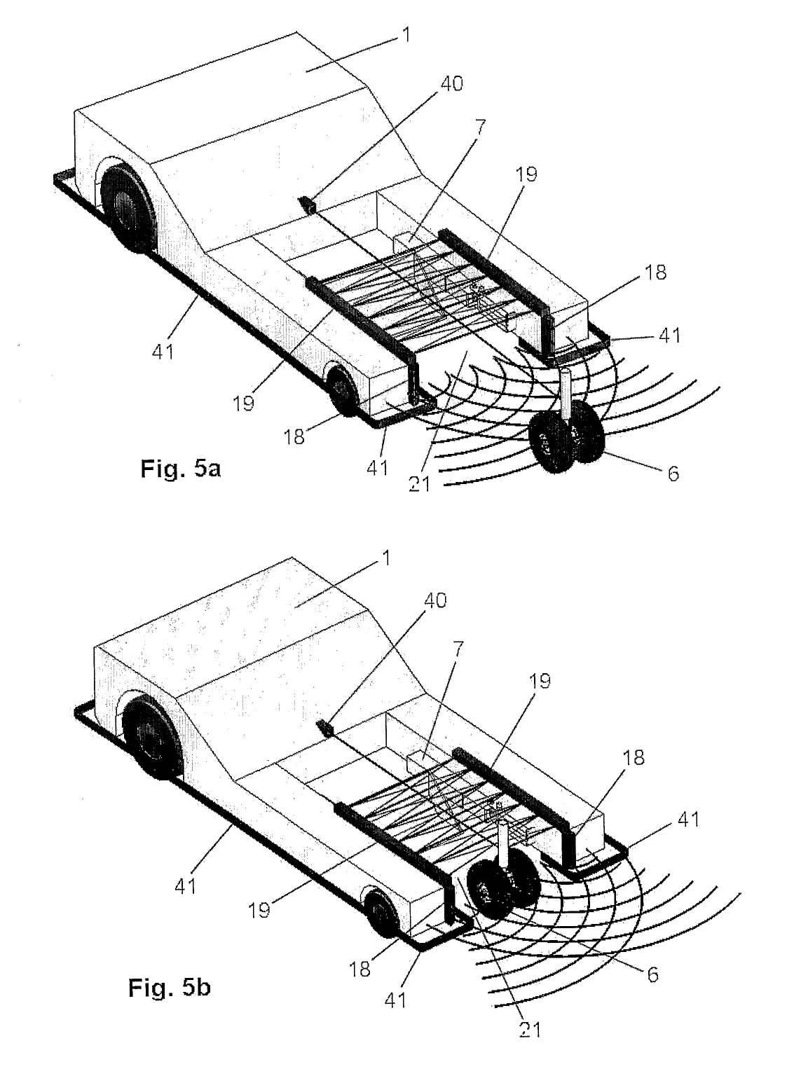

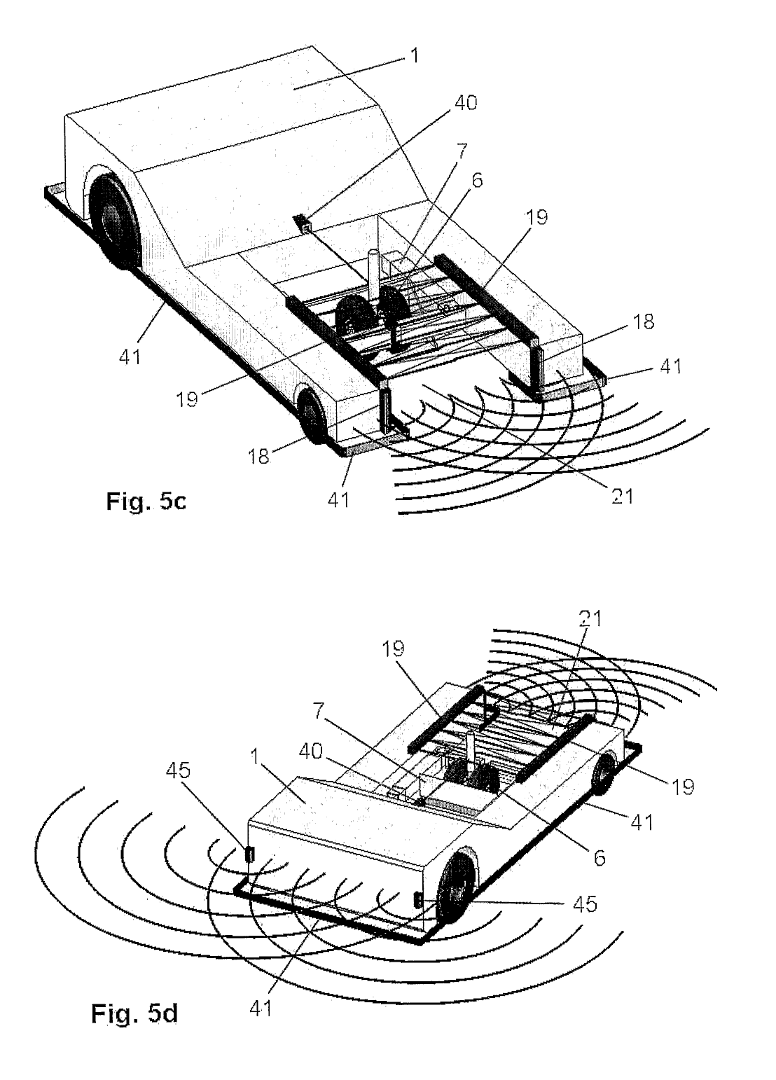

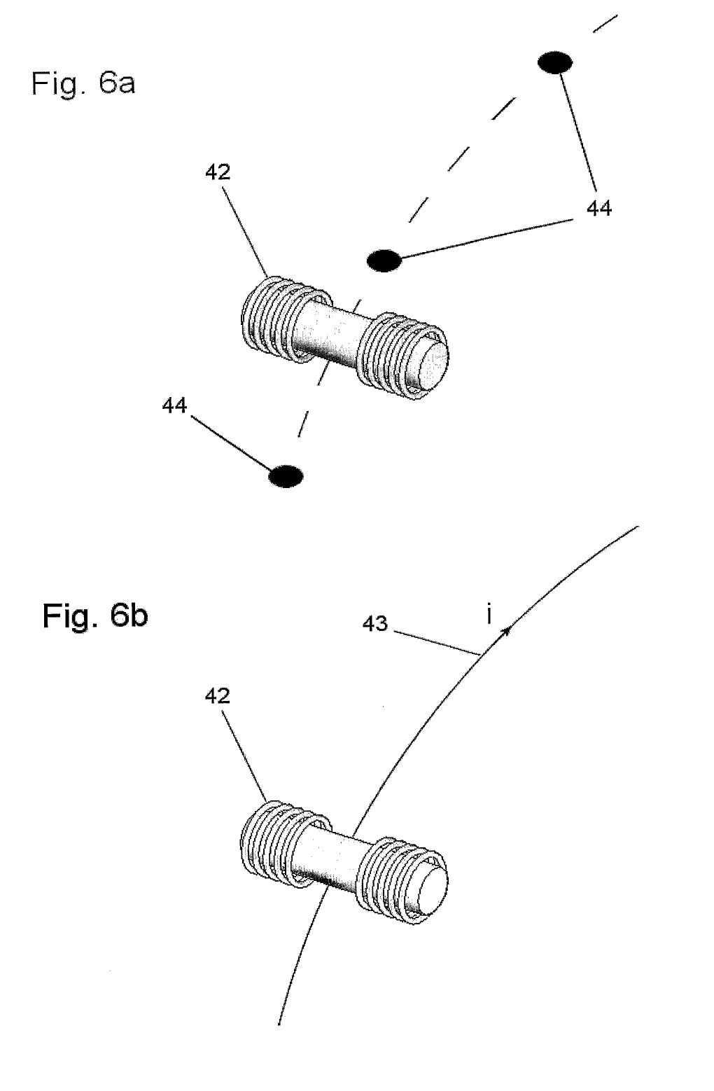

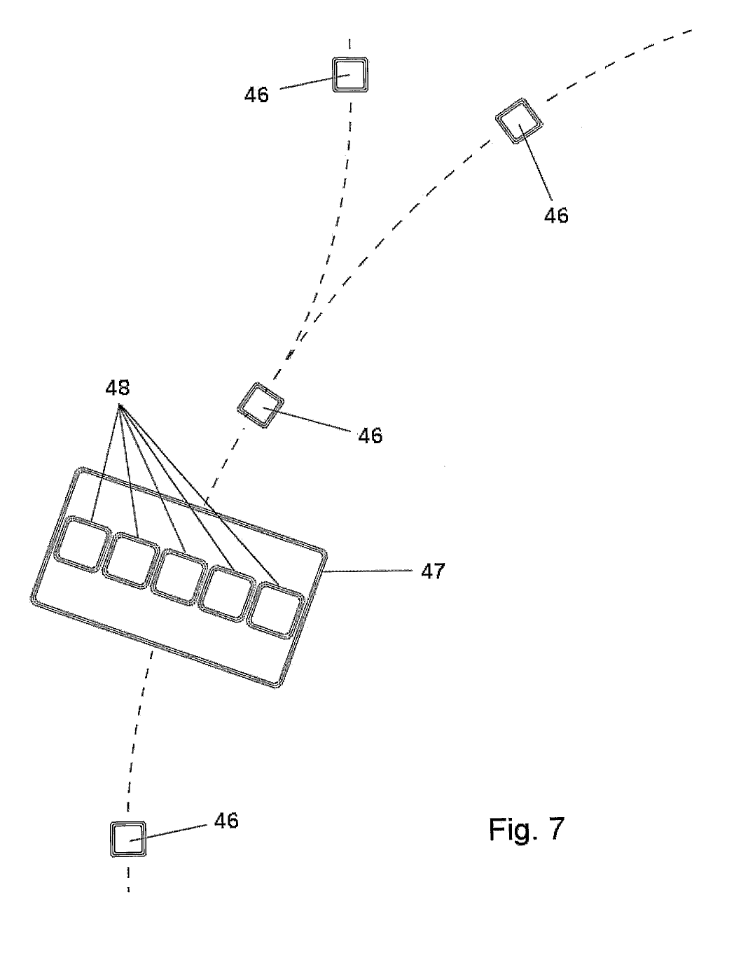

After the AGTV (1) has reached the transfer position (11) and has oriented itself, it drives up to the landing gear (6) of the aircraft (2) so that the receiving device (7) can automatically pull in the landing gear (6). Depending on the navigation system used, the approach to the landing gear (6) of the aircraft (2) is assisted by proximity sensors (18) on the AGTV (1) and/or by stationary sensors at (13) and/or in (14) the transfer area (4). The sensors (13) at the transfer area (4) generate for this purpose a graticule that can be used to determine the exact transfer position (11) of the landing gear (6) of the aircraft (2) in the transfer area (4). Inductively, capacitively and/or load-dependently operating sensors (14) in the transfer area (4) also help to precisely determine the transfer position (11) of the landing gear (6) of the aircraft (2) in the transfer area (4). Stationary sensors at (13) and/or in (14) the transfer area (4) can also be used, either individually or in combination. After the approach process, the final orientation of the AGTVs (1) with the receiving device (7) at the landing gear (6) of the aircraft (2) is accomplished by means of positioning sensors (19) and a device for distance measurement (40). For this purpose, the positioning sensors (19) generate a graticule that can be used to determine the exact position of the landing gear (6) of the aircraft (2) in the receiving space (21) of the AGTV (1). The distance measurement (40) is performed by radar-, laser- or ultrasound-based measurement systems or a combination of the different measurement systems. A radar-based measurement system is especially advantageous, since it not only performs distance measurement, but also supplies position data for the approach of the AGTV (1) to the landing gear (6) of the aircraft (2). The use of image recognition systems is also advantageous for precisely determining the position and orientation of the receiving space (21) in the AGTV (1) relative to the landing gear (6) of the aircraft (2). Steering modes that can be changed as the situation dictates, as illustrated in FIGS. 3a to 3c, facilitate the precise approach of the AGTV (1) to the landing gear (6) of the aircraft (2) and also permit better maneuverability as the aircraft (2) is being pushed back from a destination/parking position or from a passenger boarding gate (8).

Once the aircraft (2) is received by the AGTV (1), a signaling device at the transfer area (4) signals the pilot to unlock the steering mechanism of the aircraft (2) and release the brakes. Optionally, the AGTVs (1) and the aircraft can also be equipped with a wireless communication and remote control unit (55), enabling the AGTV (1) to independently control the unlocking and locking of the steering mechanism and the release and setting of the brakes of the aircraft (2). The tandem vehicles are then guided by the guidance and management system (49) from the transfer position (11) to, for example, a passenger boarding gate (8) or a remote position (10). After the towing task has been completed, the AGTV (1) sets the aircraft (2) back down. The guidance and management system (49) then orders the AGTV (1) on to the next towing task or to a staging area (5) or leaves it at the aircraft (2), depending on the needs of the moment. After the aircraft (2) has undergone ground handling, it is picked up again by an AGTV (1) and towed to another transfer area (4), where, shortly before clearance for takeoff, the engines of the aircraft (2) are started and the “spool-up time” specified by the manufacturer of the aircraft is allowed to elapse before it taxis to the takeoff runway under its own power.

Several navigation methods are available in principle for controlling the AGTVs (1), and can be used either independently or in combination.

Transponders (46) have major advantages as route markers. For one thing, they make it possible to store data along the route; for another, due to the variety of models available, they can be installed on the roadway without elaborate construction. In addition to the data stored in the transponder (46), the position of the latter is also important for controlling an AGTV (1). In the case of transponder control, the navigation sensors (15) located under the AGTV (1) consist of read/write antennas (47) for evaluating the data stored in the transponders (46), and of antenna arrays (48) that determine the position of the maximum of the transponder signal, from which the position of the transponder (46) transversely to the roadway can be obtained. With the aid of the data from a driven-over transponder (46), its exact position under the AGTV (1) and a map (56) of the airfield stored in a path computer (51), the respective next transponder (46) on the current route is driven to.

With the use of a satellite navigation system (50), the current position of the AGTV (1) is continuously received by its navigation antenna (16) and passed on to the path computer (51). The rest of the route is then determined from the position received by the satellite navigation system (50) and a map (56) of the airfield stored in the path computer (51). To increase the accuracy of the position determination, it is advantageous to have a stationary reference station in the vicinity of the routes.

In the case of magnetic marker based control, magnetic strips or magnetic markers (44) are installed along the route. Their design also enables them to be installed on the roadway without elaborate construction. The navigation sensors (15) used are coils (42) that are used to determine the position of the maximum of the magnetic field of the magnetic markers (44), from which the positions of the magnetic markers (44) transversely to the roadway can be obtained. With the aid of the data giving the exact positions of the magnetic markers (44) under the AGTV (1) and a map (56) of the airfield stored in the path computer (51), the next magnetic markers (44) on the current route are driven to.

Inductive control functions identically to magnetic marker based control, except that the magnetic strips or magnetic markers (44) are replaced by a current-conducting wire, the lead wire (43). This method enables the path computer (51) to perform continuous course correction without using a map (56) of the airfield.

In the navigation methods in which the route must be interpolated between two route markers and in the case of satellite navigation, an additional inertial navigation system (52) in the AGTV (1) is advantageous but not mandatory. An inertial navigation system (52) increases the accuracy of control of the AGTV (1) and also permits course corrections between two route markers. In addition, with route interpolation where individual path markers have failed, an inertial navigation system (52) helps the vehicle skip these path markers and drive on to the next ones that are operational.

All aircraft-specific data relevant to the towing operation, such as, for example, maximum acceleration, maximum deceleration, turning radius, etc., are stored in an aircraft database (54) in the vehicle control system. Having aircraft-specific data available directly in the vehicle control system of the AGTV (1) considerably reduces data traffic between the AGTV (1) and the guidance and management system (49).

The guidance and management system (49) is composed of one or more computer(s) that handle(s) collision- and conflict-free routing of the AGTVs (1) over the entire airfield and one or more visual display unit workstations (HMIs) from which the operating personnel operate and monitor the system. The guidance and management system (49) is advantageously networked with air traffic control or takeoff and landing control, so that the necessary information regarding aircrafts (2) that are coming in for a landing can be acquired directly by the guidance and management system (49) and information on aircrafts (2) that are ready for takeoff can be passed on directly to takeoff control. Communication between the guidance and management system (49) and the AGTVs (1) takes place wirelessly, via a radio antenna (17).

The guidance and management system (49) also evaluates all data concerning the current status of each individual AGTV (1), which data are collected by a diagnostic unit (53) in the vehicle control system. The status data make it possible to perform preventive maintenance on the AGTVs (1) and to refuel them in timely fashion, before failures and service interruptions can occur.

If the guidance and management system (49) is expanded via a software module designed to simulate a virtual airfield, the training and instruction of operating personnel can take place without interfering with actual operations.

The AGTVs (1) are equipped with a multilevel collision protection system that serves to detect obstacles in any driving situation. Collision sensors (45) at the front of each AGTV (1) scan the road an ample distance ahead of the vehicle, to detect potential obstacles well in advance even at high speeds. The AGTVs (1) are also equipped with a proximity and mechanical anti-collision system (41) that extends around the vehicle. This anti-collision system (41) is effective particularly at low speeds and prevents collisions especially when approaching the landing gears (6) of aircrafts (2) and when passing through areas where other vehicles or pedestrians are likely to be encountered.

The AGTVs (1) also have an auxiliary driver's console, which makes it possible for the AGTV (1) to be operated in manual mode by a driver. The option of manual-mode operation of the AGTVs (1) is advantageous when, for example, space conditions at a passenger gangway (8) preclude automated or safe operation, or an AGTV (1) has to go out of range of automatic guidance by the guidance and management system (49) for maintenance purposes. Depending on the type and size of the AGTV (1), the auxiliary driver's console can be permanently tied to the AGTV (1), or it can, for example, be a cableless or cable-connected portable steering and operating console.

Diesel-electric or diesel-hydraulic engines are especially advantageous for powering the AGTVs (1), although this is not to be taken as limitative. Regardless of the type of power used, even battery-electric-powered AGTVs (1) must be refueled or recharged after a certain period of operation. An automated system for maneuvering aircrafts on the ground is therefore usefully, but not necessarily, equipped with a system for automatically refueling or recharging the AGTVs (1). It includes one or more stations (12) which the AGTVs can drive up to independently, as needed, in order to be fueled up fully automatically. If electric power transmission is used by itself, a decentralized solution is advantageous, with fully automatic charging stations at the parking spaces inside the staging areas (5).

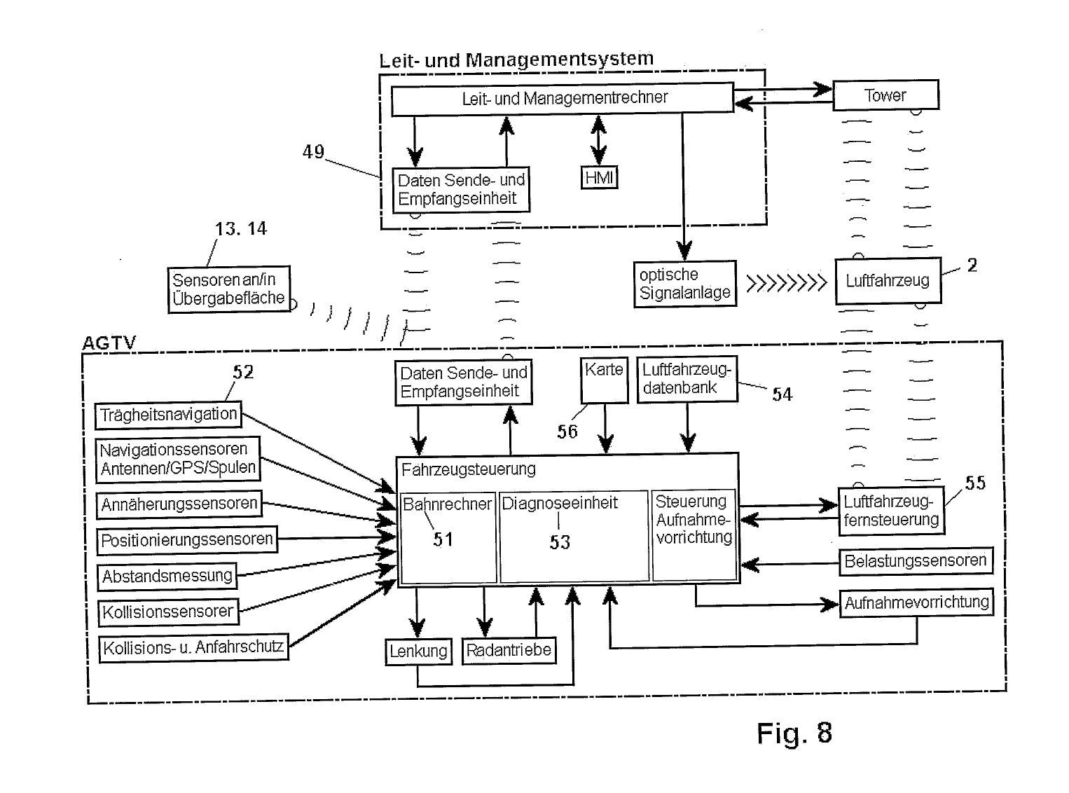

### KEY TO FIG. 8

a. Guidance and management system
b. Guidance and management computer
c. Data transmitting and receiving unit
d. Sensors at/in transfer area
e. Optical signal system
f. Aircraft
g. Inertial navigation
h. Navigation sensors Antennas/GPS/coils
i. Proximity sensors
j. Positioning sensors
k. Distance measurement
l. Collision sensors
m. Proximity and mechanical anti-collision system
n. Map
o. Aircraft database
p. Vehicle control system
q. Path computer
r. Diagnostic unit
s. Receiving-device control
t. Aircraft remote control
u. Load sensors
v. Receiving device
w. Steering
x. Wheel drives

1-13. (canceled)

14. A system for maneuvering aircrafts (2) on the ground between the transfer areas (4) available both for arriving and for departing aircrafts (2) and the target/parking positions for the ground handling of said aircrafts (2), based on vehicles (1) that can be driverlessly navigated on an airfield by optical or inductive methods, by means of transponders, magnetic markers, GPS or a combination of the aforesaid methods, and can be controlled in a collision- and conflict-free manner by a guidance and management system, characterized in that said vehicles (1) are outfitted as towbarless towing vehicles comprising a receiving space (21) and a device (7) for independently receiving the landing gear (6) in said receiving space (21) of said vehicle (1), and are provided to drive up to the landing gear (6) with their receiving space (21) presented thereto, and are equipped for this purpose with sensor systems that enable said vehicle (1) to drive up to said landing gear (6) safely and said landing gear (6) to be precisely positioned in said receiving space (21).

15. The system for maneuvering aircrafts (2) as in claim 14, characterized in that said receiving device (7), aided by sensors, independently pulls in said landing gear (6).

16. The system for maneuvering aircrafts (2) as in claim 14, characterized in that sensors on said vehicle (1) and/or at or in said transfer area (4) are provided to increase the positional accuracy of said vehicles (1) as they approach the landing gears (6) of said aircrafts (2).

17. The system for maneuvering aircrafts (2) as in claim 14, characterized in that said vehicles (1) have a single-axle steering mode for normal cornering, a crab steering mode for tight cornering, and a multidirectional steering mode for diagonal travel, and can be switched between the different steering modes while the vehicles (1) are being maneuvered.

18. The system for maneuvering aircrafts (2) as in claim 14, characterized in that said vehicles (1) and said aircrafts (2) are equipped with a wireless communication and control unit, by means of which said vehicles (1) are able to independently control the unlocking of the nose gear steering, the parking brake, and the main landing gear brakes of said aircrafts (2).

19. The system for maneuvering aircrafts (2) as in claim 14, characterized in that said vehicles (1) have an auxiliary driver's console that enables said vehicles (1) to be operated manually.

20. The system for maneuvering aircrafts (2) as in claim 14, characterized in that said vehicles (1) can be refueled or recharged automatically at one or more stations (12) on the airfield
